(19) United States
(12) Patent Application Publication
(10) Pub. No.: US 2003/0079622 A1
(43) Pub. Date: May 1, 2003

(54) Container for compacted waste

(76) Inventor: Salvatore P. LaBarbera, Eldorado Hills, CA (US)

Correspondence Address: Neal L. Rosenberg, Esq, AMSTER, ROTHSTEIN & EBENSTEIN, 90 Park Avenue, New York, NY, 10016, US

(21) Appl. No.: 09/999,127

(22) Filed: Oct. 31, 2001

(51) Int. Cl. B30B 15/02

(52) U.S. Cl. 100/225

(57) ABSTRACT

A container for the receipt, storage and discharge of compacted waste has a housing defining an interior surface formed by a pair of opposed lateral sides and an opposed top and bottom connecting the sides. The housing has opposed input and output ends, the input end including a connector for interconnecting with a waste compactor, and the output end including a door for temporarily closing the output end. The lateral sides form interior surface portions tapering outwardly from the input end to the output end.

### BACKGROUND OF THE INVENTION

The present invention relates to a container for the receipt, storage and discharge of compacted waste, and more particularly to a closed-top container having an enhanced storage capacity.

Containers for the receipt, storage and discharge of compacted waste are typically either open-top or closed-top. Open-top containers and their use are illustrated in various patents such as Bergmann U.S. Pat. No. 4,426,925; U.S. Pat. No. 4,467,714 and U.S. Pat. No. 4,524,685. Closed-top containers and their use are illustrated in Bergmann U.S. Pat. No. 5,195,432. Discharge of compacted waste from an open-top container is typically not problematic as the entire open top is available for discharge of the compacted waste from the container. On the other hand, discharge of compacted waste from a closed-top container may be even more problematic than the receipt and storage of compacted waste therein.

Thus, where the compacted waste has a relatively low density (for example, because the waste was not highly compressible), gravity alone may not be sufficient to force its discharge from the container through the opening at the output or discharge end. In such circumstances, it may be necessary to fill the container with compacted waste to less than its full capacity, thereby to reduce the friction between the exterior of the compacted waste and the interior surface of the container which resists discharge of the waste. However, a failure to utilize the full capacity of the container due to a limitation on the degree of compacting is economically counterproductive as, for the same weight of waste, more of the expensive containers must be used, higher labor and transport costs must be incurred to transport the containers between the site of use and the site of discharge (i.e., the landfill or dump), and higher landfill fees will be charged when such landfill fees are based on the volume of the deposit rather than the weight of the deposit.

What appears to be an obvious solution to the problem—namely, the use of larger containers—is not practical for a variety of different reasons. For example, the space available for a container at a given use site may be limited. Where the container must be transported by truck on public highways between the use and landfill sites, laws and regulations may limit the width of the container being transported. Where the container must be shipped on a container-type ship, the “high cube ocean containers” commonly used therein limit the size of the waste container shipped therein.

Accordingly, it is an object of the present invention to provide a container for the receipt, storage and discharge of compacted waste which enables maximum utilization of the available interior volume of the container.

Another object is to provide such a container wherein in a preferred embodiment the interior design of the container enables the receipt and storage therein of highly compacted waste (regardless of the density of the compacted waste) while still facilitating discharge thereof.

A further object is to provide in a preferred embodiment such a container which may be economically manufactured in a variety of different sizes.

It is also an object of the present invention to provide such a container which is simple and economical to construct, maintain and use.

### SUMMARY OF THE INVENTION

It has now been found that the above and related objects of the present invention are obtained in a closed-top container for the receipt, storage and discharge of compacted waste. The container comprises a housing defining an interior surface formed by a pair of opposed lateral sides and an opposed top and bottom connecting the sides, the housing has opposed input and output ends, the input end including means for interconnecting with a waste compactor, and the output end including means for temporarily closing the output end. The lateral sides form interior surface portions tapering outwardly from the input end to the output end.

In a preferred embodiment, the top also forms an interior surface portion tapering upwardly from the input end to the output end, and preferably the bottom also forms an interior surface portion tapering downwardly from the input end to the output end. The cross-sectional area defined by the interior surface of the housing increases from the input end to the output end. Preferably the interior surface portions and the cross-sectional area taper in a smooth, gradual, and continuous manner.

In another preferred embodiment, a cross-section of the housing defines four interior corners at junctions of the sides with the top and bottom, the interior corners being smoothly arcuate.

In yet another preferred embodiment, the sides define interior surface portions bulging or bowing laterally outwardly intermediate the top and bottom, the top defines an interior surface portion bulging or bowing upwardly intermediate the sides, and the bottom defines an interior surface portion bulging or bowing downwardly intermediate the sides.

The present invention also encompasses, in combination, the container and a waste compactor, including means for interconnecting the container and the compactor.

### BRIEF DESCRIPTION OF THE DRAWING

The above and related objects, features and advantages of the present invention will be more fully understood by reference to the following detailed description of the presently preferred, albeit illustrative, embodiments of the present invention when taken in conjunction with the accompanying drawing wherein:

FIG. 1 is a schematic sectional elevational view of a container according to the present invention,with the compacted waste being shown in dashed line;

FIG. 2 is a schematic top plan view thereof, showing the compacted waste (in dashed line)being discharged and the top wall of the container removed for expository purposes;

FIG. 3 is an isometric view of the housing;

FIG. 4 is an exploded view of the housing;

FIG. 5 is an end elevational view of the housing from the input end; and

FIG. 6 is a sectional view thereof to an enlarged scale, taken along the line 6-6 of FIG. 5.

### DETAILED DESCRIPTION OF THE PREFERRED EMBODIMENTS

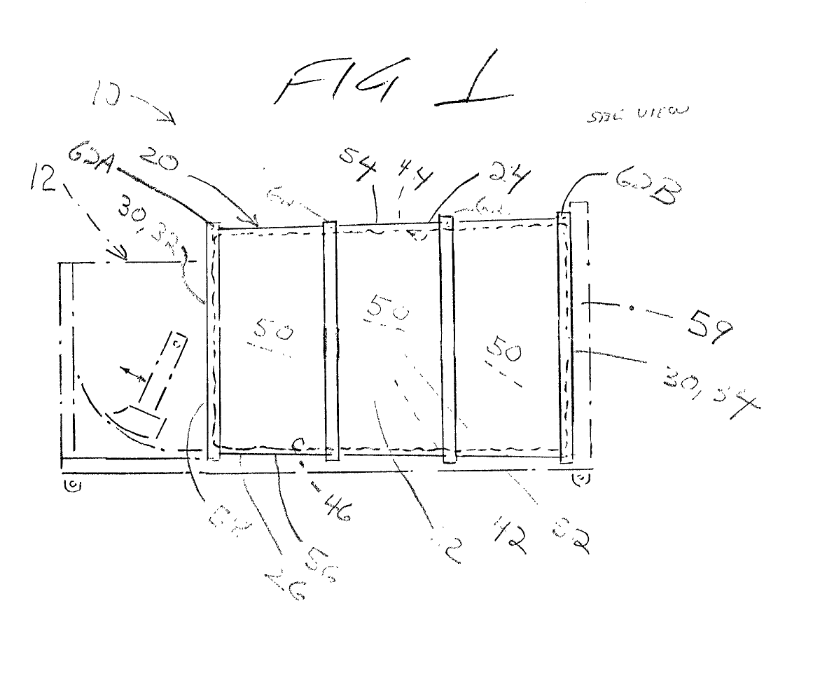

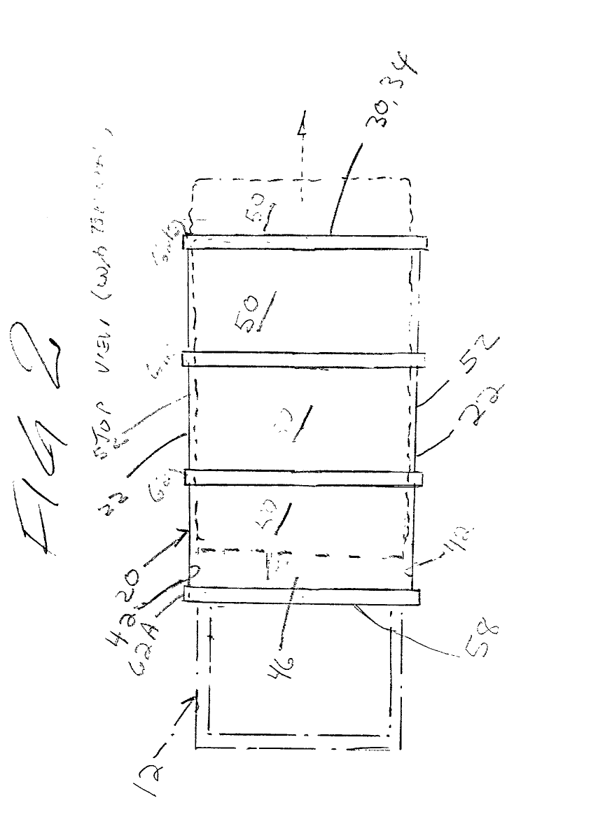

Referring now to the drawing, and in particular to FIGS. 1-3 thereof, therein illustrated is a closed-top container according to the present invention, generally designated by the reference numeral 10. The container 10 is configured and dimensioned for the receipt of compacted waste from a compactor, generally designated 12. The compactor 12 (illustrated in phantom line) may be of any conventional design suitable for use with a closed-top container 10, although preferably of the design described and shown in Bergmann U.S. Pat. No. 5,195,432. The container 10 comprises a housing, generally designated 20, defining an interior surface formed by a pair of opposed lateral sides 22 and an opposed top 24 and bottom 26 connecting the sides 22. The housing 20 thus defined has opposed ends, generally designated 30, including an input end 32 and an output end 34. The input end 32 includes a charge box plate for interconnecting with the compactor 12 (located in a charge head or charge box) during compacting of the waste, as illustrated in FIG. 1. The output end 34 includes door means for temporarily closing the output end 34 during receipt and storage of the compacted waste, as illustrated in FIG. 1 and for temporarily opening the door during discharge of the compacted waste, as illustrated in FIG. 2. The housing 20, as described hereinabove, is conventional in nature and hence need not be described herein in further detail.

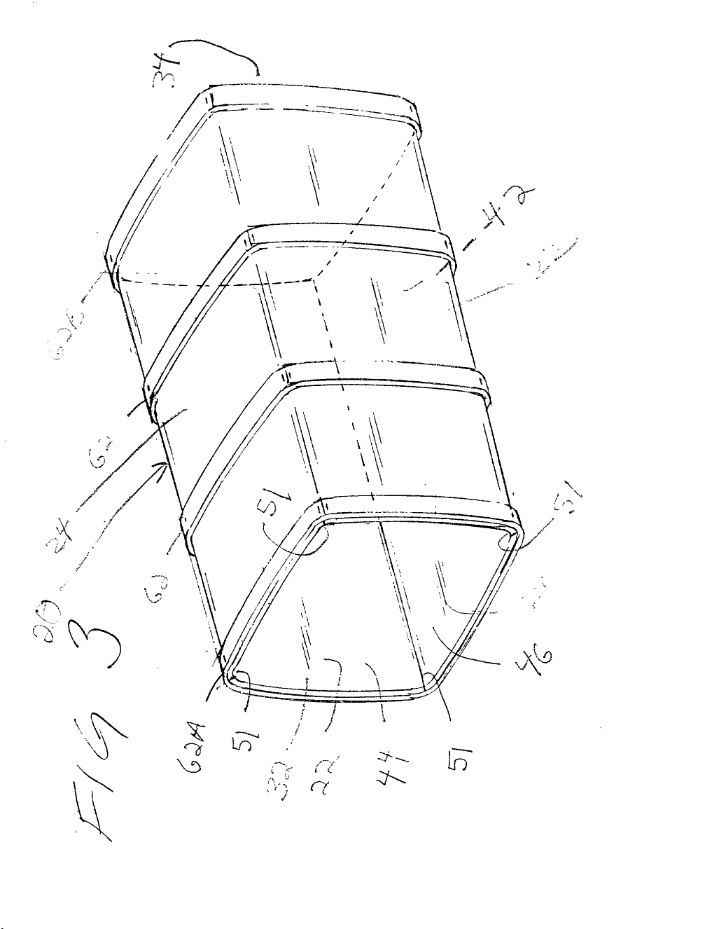

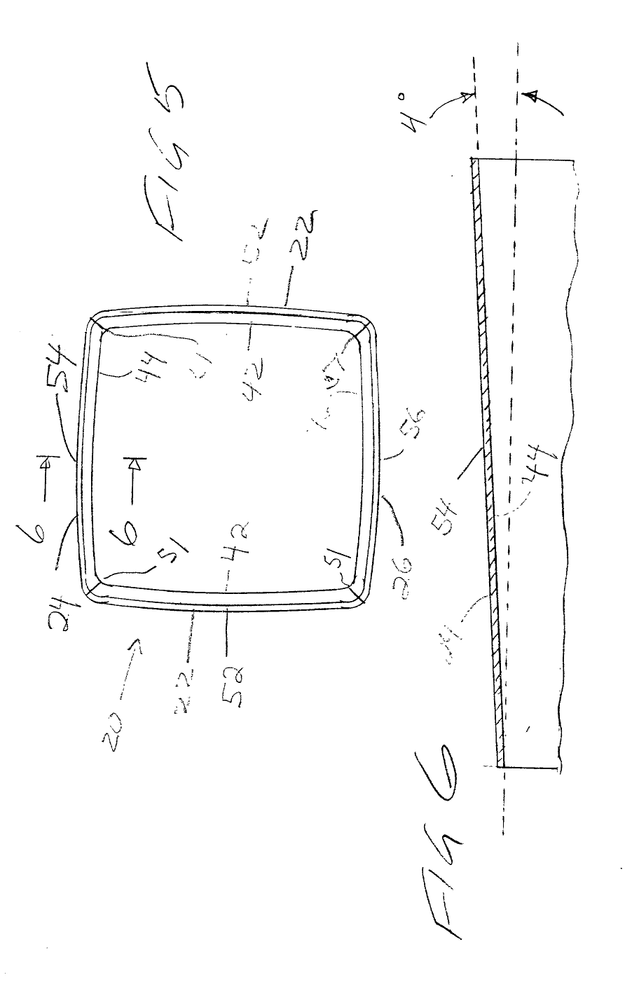

Turning now to the various novel features of the present invention, and referring to FIGS. 3-6 in particular, to reduce friction between the exterior surface of the compacted waste and the interior surface of the housing 20, the lateral sides 22 of housing 20 form interior surface portions 42 tapering outwardly from the input end 32 to the output end 34. Similarly, the top 24 forms an interior surface portion 44 tapering upwardly from the input end 32 to the output end 34. While preferably the interior surface portion 42 formed by each lateral side 22 tapers outwardly, in fact only the interior surface portion 42 of one side 22 must taper outwardly to obtain the advantages of the present invention. Similarly, while the bottom 26 may form an interior surface portion 46 tapering downwardly from the input end 32 to the output end 34, the advantages of the present invention are preferably obtained with only the upward tapering of the interior surface portion 44 formed by the top 24. Preferably, the interior surface portions 42, 44 and optionally 46 smoothly, gradually and continuously taper from the input end 32 to the output end 34.

It will be appreciated that, regardless of whether taper is provided by the interior surface portions 42 formed by one or both lateral sides 22 and/or the interior surface portions 44, 46 formed by one or both of the top and bottom 24, 26, the cross-sectional area defined by the interior surface of the housing 20 increases from the input end 32 to the output end 34 to reduce friction and binding subsequent to initial movement of the compacted waste 50. When all four tapers are present in a container according to the present invention having a length of 4.8 yards, the interim cross-sectional area may increase from 4.6 square yards at input end 32 to 5.6 square yards at output end 34 to provide a 27 cubic yard interior volume.

The increase is preferably smooth, gradual and continuous. A preferred angle of taper is 1-5°, preferably 3-5°, for the interior surface portions 42, 44, 46. Preferably the output end 34 is about 8″ greater in height and about 8″ greater in width than the input end 32, although this difference may vary depending upon the overall length of the container.

The outward, upward and optionally downward tapering of interior surface portions 42, 44 and 46, and indeed the resultant smoothly gradually and continuously increasing cross-sectional area defined by the interior surface of the housing, is a factor in enabling full utilization of the interior volume of the housing 20 at the highest possible compression ratio. Even where the compacted waste 50 is of relatively low density and thus quite light, so that gravity alone would not ordinarily be able to overcome the friction between the outer surface of the compacted waste and the interior surface of the housing 20, the novel design of the housing interior facilitates removal of the compacted waste therefrom simply by tipping of the container 10. The slightest initial movement of the compacted waste 50 way from the input end 32 and towards the output end 34 breaks the frictional grip of the interior surface portions 42, 44 on the compacted waste 50 because, in any given vertical plane transverse to the longitudinal axis of housing 20, the outer dimensions of the compacted waste are now less than the inner dimensions of the housing 20, as best seen in FIG. 2. In other words, the cross-sectional area defined by the interior surface of the housing 20 in a given vertical plane becomes greater than the cross-sectional area defined by the exterior surface of the compacted waste 50.

As the housing walls are of constant thickness, the overall outer dimensions fo the housing are similarly tapered. As FIGS. 1 and 2 are schematic in nature, the walls 22, 24, 26 are illustrated therein without thickness.

Assuming that the interior surface portion 46 defined by the bottom 26 does not taper downwardly from the input end 32 to the output end 34, after the initial movement of the compacted waste 50, the remaining friction between the bottom surface of the compacted waste and the interior surface 46 of bottom 26 during discharge is a function of the weight of the compacted waste only, without any additional component reflecting the pressure being exerted on the compacted waste by the other interior surface portions 42, 44.

To further reduce friction, and also to reduce binding, between the exterior surface of the compacted waste and the interior surface of the housing 20, in a preferred embodiment the housing 20 defines at the four interior corners 51—that is, at the junctions of the sides 22 with the top 24 and bottom 26—smoothly arcuate curves rather than perpendicular adjoining surfaces 22, 24, 26. A preferred radius of curvature for each interior corner is about 4″.

To further reduce friction, and also to reduce binding, between the exterior surface of the compacted waste and the interior surface of the housing 20, in a preferred embodiment the lateral sides 22 define interior surface portions 42 bulging or bowing outwardly at 52 intermediate the top 24 and bottom 26 while the top 24 and bottom 26 define interior surface portions 44, 46 bulging or bowing upwardly at 54 and downwardly at 56, respectively, intermediate the sides 22. The bulging or bowing also maximizes the capacity of the interior of the housing without greatly increasing its overall outer dimensions. A preferred radius of curvature for each bulge or bow is about 415″.

Each of the three primary features of the present invention—that is, the tapering, the curved interior corners, and the bulging or bowing interior surface portions—may be used by itself or in combination with one or both of the other primary features.

Referring now to FIGS. 1 and 2, therein illustrated are, in combination, the above-described container 10 and waste compactor 12. The container 10 includes at input end 32 a charge plate 58 which opens for functionally interconnecting the interiors of the container 10 and waste compactor 12, and at output end 34 a discharge door 59 which opens (typically by pivoting upwardly) for functionally interconnecting the interior of the container 10 and the discharge site. The combination of container 10 and compactor 12 may be interconnected by any of the connecting means well known in the art.

The housings 20 are typically shipped by boat in what are generally referred to “high cube ocean containers” having a maximum dimension of 40 ft. and are typically transported between use and landfill sites on special trucks having a maximum width of 8 ft. to comply with local laws and regulations. Accordingly, the maximum dimensions of a container, if it is to be suitable for transport in the high cube ocean containers and the special trucks must be limited to 40 ft. in length and 8 ft. in width. The high cube ocean containers typically additionally place a limit of 9 ft. on the height.

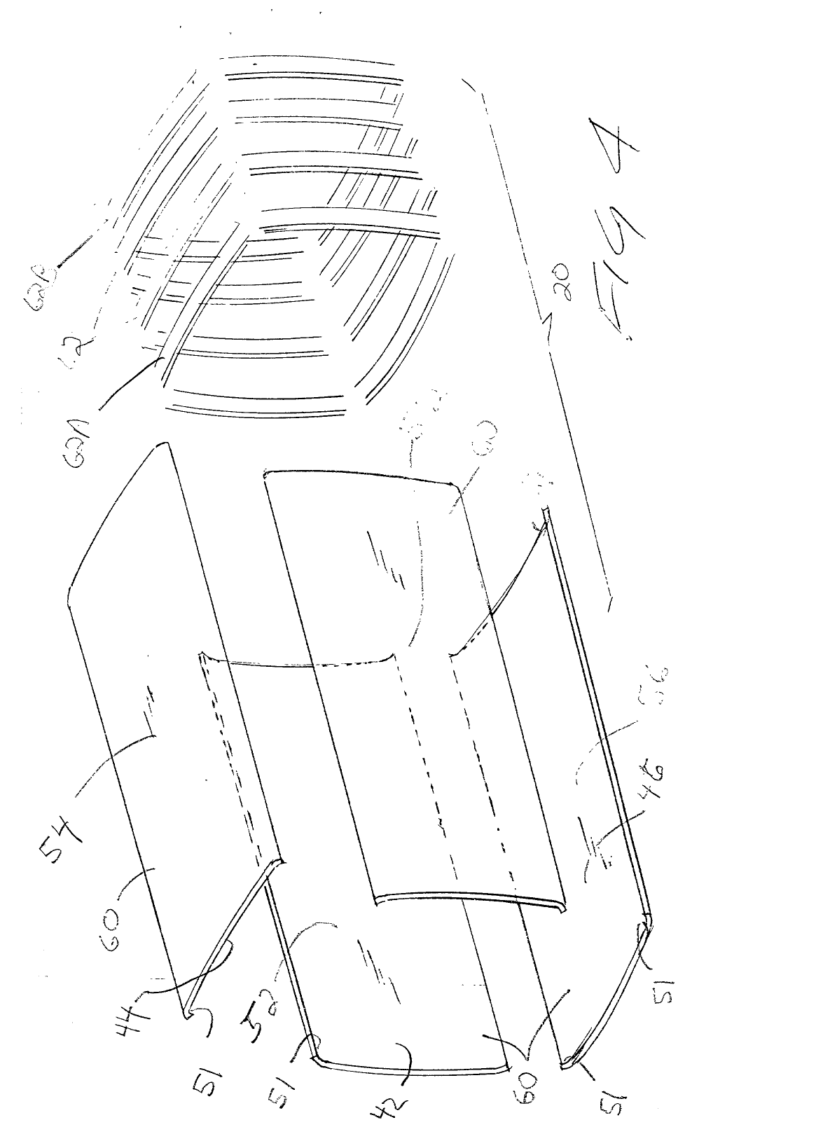

Containers 10 of different capacity (that is, having a different interior volume) typically differ in length (up to 40 ft., preferably about 15-20 ft.) rather than in height or width. Typically, as best seen in FIG. 4, the container 10 consists of four quadrants or sections 60 of equal length and like curvature to provide interior volumes of, e.g., 12, 15, 18, 23 or 27 cubic yards. The four quadrants or sections 60 are joined together (e.g., by welding) along their long edges.

Generally similarly shaped flanges 62A, 62B are provided at the input end 32 for connection to a waste compactor 12 and at the output end 34 for mounting of an upwardly pivotable discharge door 64, respectively. A plurality of outwardly extending flanges 62 (typically two, three or four) are disposed intermediate end flanges 62A, 62B. The various flanges 62, 62A, 62B act as braces to assist in maintaining the welded sections 60 together and are of similar inner and outer dimensions, although the dimensions of each flange in its plane varies to accommodate the bulging or bowing of the lateral sides 22, top 24, and bottom 26 (so that it is thinner at the middle of the sides, top and bottom thereof than at the corners thereof) and to accommodate the overall taper of the housing outer surface (which reflects the overall taper of the housing inner surface).

The novel design of the container 10 allows it to receive, store and discharge a weight of compacted waste several times that of a container of comparable volume, but without the novel features of the present invention. Thus, a container according to the present invention with curved interior comers and bulging interior surfaces typically exhibits an increase of about ______% in holding capacity (i.e., weight of compacted waste per container) relative to a conventional container of comparable internal volume, but without curved interior corners and without bulging or bowing interior surfaces. Accordingly, a small decrease in the available interior volume of the container can be sustained without materially degrading the efficiency of the container. Thus, the provision of a cross-sectional area at the input end 32 which is less than the cross-sectional area at the output end 34 is easily absorbed into the overall superior profitability of the container according to the present invention.

In order to effect the economies of mass production, the various-size containers are manufactured on a jig suitable for use on the largest of the containers. To form smaller containers, a length of each of the quadrants or sections 60 is cut off at the input end 32 or simply not formed. As a practical matter, this construction lends itself to economies of scale, as the jig is used to construct each of the various quadrants or sections 60 without requiring angular modification for each section. Because the output ends 34 of the various sized containers 10 are of the same configuration and dimensions, the discharge doors 64 pivotally secured thereto are of the same configuration and dimensions, thereby effecting further economics of scale.

To summarize, the present invention provides a container for the receipt, storage and discharge of compacted waste which enables maximum utilization of the interior volume of the container, the interior design of the container enabling the receipt and storage therein of a large volume of highly compacted waste (regardless of the density of the compacted waste) while still facilitating discharge thereof. The container may be economically manufactured in a variety of different volumes and is simple and economical to construct, maintain and use.

Now that the preferred embodiments of the present invention have been shown and described in detail, various modifications and improvements thereon will become readily apparent to those skilled in the art. Accordingly, the spirit and scope of the present invention is to be construed broadly and limited only by the appended claims, and not by the foregoing specification.

I claim:

1. A container for the receipt, storage and discharge of compacted waste, comprising:
a housing defining an interior surface formed by a pair of opposed lateral sides and an opposed top and bottom connecting said lateral sides, said housing having opposed input and output ends, said input end including means for interconnecting with a waste compactor, and said output end including means for temporarily closing said output end;
said lateral sides forming interior surface portions tapering outwardly from said input end to said output end.

2. The container of claim 1 wherein said lateral sides form interior surface portions smoothly, gradually and continuously tapering outwardly from said input end to said output end.

3. The container of claim 1 wherein said top forms an interior surface portion smoothly, gradually and tapering upwardly from said input end to said output end.

4. The container of claim 3 wherein said top forms an interior surface portion smoothly, gradually and continuously tapering upwardly from said input end to said output end.

5. The container of claim 1 wherein the cross-sectional area defined by the interior surface of said housing increases from said input end to said output end.

6. The container of claim 6 wherein the cross-sectional area defined by the interior surface of said housing smoothly, gradually and continuously increases from said input end to said output end.

7. The container of claim 1 wherein a cross-section of said housing defines four interior corners at junctions of said lateral sides with said top and bottom, said interior corners being smoothly arcuate.

8. The container of claim 1 wherein said lateral sides define interior surface portions bulging or bowing laterally outwardly intermediate said top and bottom.

9. The container of claim 8 wherein said top defines an interior surface portion bulging or bowing upwardly intermediate said lateral sides.

10. The container of claim 9 wherein said bottom defines an interior surface portion bulging or bowing downwardly intermediate said lateral sides.

11. In combination, the container of claim 1 and a waste compactor, said combination including means for interconnecting said container and said compactor.

12. A container for the receipt, storage and discharge of compacted waste, comprising:
a housing defining an interior surface formed by a pair of opposed lateral sides and an opposed top and bottom connecting said sides, said housing having opposed input and output ends, said input end including means for interconnecting with a waste compactor, and said output end including means for temporarily closing said output end;
said lateral sides forming an interior surface portions continuously tapering outwardly from said input end to said output end, and said top forming an interior surface portion smoothly, gradually and continuously tapering upwardly from said input end to said output end;
whereby the cross-sectional area defined by the interior surface of said housing smoothly, gradually and continuously increases from said input end to said output end.

13. The container of claim 12 wherein a cross-section of said housing defines four interior corners at junctions of said lateral sides with said top and bottom, said interior corners being smoothly arcuate.

14. The container of claim 12 wherein said lateral sides define interior surface portions bulging or bowing outwardly intermediate said top and bottom, said top defines an interior surface portion bulging or bowing upwardly intermediate said lateral sides, and said bottom defines an interior surface portion bulging or bowing downwardly intermediate said lateral sides.

15. A container for the receipt, storage and discharge of compacted waste, comprising:
a housing defining an interior surface formed by a pair of opposed lateral sides and an opposed top and bottom connecting said lateral sides, said housing having opposed input and output ends, said input end including means for interconnecting with a waste compactor, and said output end including means for temporarily closing said output end;
the cross-section of said housing defining four interior corners at junctions of said lateral sides with said top and bottom, said interior corners being smoothly arcuate.

16. The container of claim 15 wherein said interior corners define a radius of curvature of about 4″.

17. The container of claim 15 wherein said lateral sides define interior surface portions bulging or bowing outwardly intermediate said top and bottom, said top defines an interior surface portion bulging or bowing upwardly intermediate said lateral sides, and said bottom defines an interior surface portion bulging or bowing downwardly intermediate said lateral sides.

18. A container for the receipt, storage and discharge of compacted waste, comprising:
a housing defining an interior surface formed by a pair of opposed lateral sides and an opposed top and bottom connecting said lateral sides, said housing having opposed input and output ends, said input end including means for interconnecting with a waste compactor, and said output end including means for temporarily closing said output end;
said lateral sides defining interior surface portions bulging or bowing laterally outwardly intermediate said top and bottom.

19. The container of claim 18 wherein said top defines an interior surface portion bulging or bowing upwardly intermediate said lateral sides.

20. The container of claim 18 wherein said bottom defines an interior surface portion bulging or bowing downwardly intermediate the lateral sides.

21. The container of claim 18 wherein said top defines an interior surface portion bulging or bowing upwardly intermediate said sides, and said bottom defines an interior surface portion bulging or bowing downwardly intermediate said sides.

22. The container of claim 21 wherein each of said interior surface portions defines a bulging or bowing having a radius of curvature of about 415″.

23. The container of claim 18 wherein a cross-section of said housing defines four interior corners at junctions of said lateral sides with said top and bottom, said interior corners being smoothly arcuate.

24. A container for the receipt, storage and discharge of compacted waste, comprising:
a housing defining an interior surface formed by a pair of opposed lateral sides and an opposed top and bottom connecting said sides, said housing having opposed input and output ends, said input end including means for interconnecting with a waste compactor, and said output end including means for temporarily closing said output end;
said lateral sides forming an interior surface portions continuously tapering outwardly from said input end to said output end, and said top forming an interior surface portion smoothly, gradually and continuously tapering upwardly from said input end to said output end;
a cross-section of said housing defining four interior corners at junctions of said lateral sides with said top and bottom, said interior corners being smoothly arcuate;
said lateral sides defining interior surface portions bulging or bowing outwardly intermediate said top and bottom, said top defining an interior surface portion bulging or bowing upwardly intermediate said lateral sides, and said bottom defining an interior surface portion bulging or bowing downwardly intermediate said lateral sides;
whereby the cross-sectional area defined by the interior surface of said housing smoothly, gradually and continuously increases from said input end to said output end.
